(19) United States
(12) Patent Application Publication
(10) Pub. No.: US 2018/0037089 A1
(43) Pub. Date: Feb. 8, 2018

(54) HEATING MODULE AND HEATER ASSEMBLY INCLUDING THE SAME

(71) Applicant: LG ELECTRONICS INC., Seoul (KR)

(72) Inventors: Jaehyun BAEK, Seoul (KR); Jaehun SHIM, Seoul (KR); Hyunwoo KIM, Seoul (KR); Hyounjeong SHIN, Seoul (KR)

(73) Assignee: LG ELECTRONICS INC., Seoul (KR)

(21) Appl. No.: 15/445,753

(22) Filed: Feb. 28, 2017

(30) Foreign Application Priority Data
Aug. 8, 2016 (KR) 10-2016-0100639

(51) Int. Cl. B60H 1/22; B60H 1/32; B60H 1/00; F24H 1/12; H05B 3/26

(52) U.S. Cl. CPC B60H 1/2221; F24H 1/121; H05B 3/265; B60H 1/00392; B60H 1/3204; H05B 2203/016; H05B 2203/021

(57) ABSTRACT

A heating module includes: an insulating case; at least one heat emitting element that is supported by the insulating case; at least one terminal plate that is arranged in the insulating case to contact the heat emitting element; and a ceramic insulator that is arranged on an outer surface of the terminal plate.

### CROSS-REFERENCE TO RELATED APPLICATIONS

The present application claims priority under 35 U.S.C. 119 to Korean Patent Application No. 10-2016-0100639 filed on Aug. 8, 2016, which is hereby incorporated by reference in its entirety.

### BACKGROUND

The present disclosure relates to a heater assembly, and more particularly to a heater assembly in which a heating module accommodated in a heat transfer pocket heats a thermal medium through the heat transfer pocket.

A vehicle may be equipped with a heater that heats air or water to heat the interior of the vehicle.

An example of such a heater may be provided in a passage for air that is supplied into the interior of the vehicle to directly heat the air supplied into the interior of the vehicle.

Another example of the heater may be connected to a heat exchanger that exchanges heat with air, through a hot water line, and may heat a thermal medium, such as water, to supply hot water to the heat exchanger.

The heater installed in the vehicle may include a heat emitting element such as a PTC (Positive Temperature Coefficient) heater or a heat emitting coil, and a connecting terminal that connects the heat emitting element and a power supply such that an electric current may flow therebetween.

### PRIOR TECHNICAL DOCUMENTS

### Patent Documents

Korean Patent Application Publication No. 10-2005-0031024 A (published on Apr. 1, 2005)

### SUMMARY

Embodiments provide a heating module that improves insulation performance and heat transfer rate, and a heater assembly including the same.

In accordance with an aspect of the present disclosure, there is provided a heating module including: an insulating case; at least one heat emitting element that is supported by the insulating case; at least one terminal plate that is arranged in the insulating case to contact the heat emitting element; and a ceramic insulator that is arranged on an outer surface of the terminal plate.

The ceramic insulator may cover both of the outer surface of the terminal plate and an outer surface surface of the insulating case.

A pair of terminal plates may be arranged in the insulating case to be spaced apart from each other, and the ceramic insulator may include: a first ceramic insulating pad that covers an outer surface of any one of the pair of terminal plates and one surface of the insulating case; and a second ceramic insulating pad that covers an outer surface of the other of the pair of terminal plates and an opposite surface of the insulating case.

The ceramic insulator further may include a third ceramic insulating pad that connects the first ceramic insulating pad and the second ceramic insulating pad.

The heating module may further include: an outer clip that presses the first ceramic insulating pad to any one of the pair of terminal plates, and presses the second ceramic insulating pad to the other of the pair of terminal plates.

The heating module may further include: an outer clip, and the ceramic insulator includes a ceramic coating layer that is coated on a surface of the outer clip, which faces the terminal plate.

A pair of terminal plates may be arranged in the insulating case to be spaced apart from each other, and the ceramic coating layer includes: a first ceramic coating layer that is coated on a surface of the outer clip, which faces any one of the pair of terminal plates, to cover both of an outer surface of any one of the pair of terminal plates and one surface of the insulating case; and a second ceramic coating layer that is coated on a surface of the outer clip, which faces the other of the pair of terminal plates, to cover both of an outer surface of the other of the pair of terminal plates and an opposite surface of the insulating case.

The ceramic insulator may include a ceramic coating layer that is coated on the outer surface of the terminal plate and the outer surface of the insulating case.

A pair of terminal plates may be arranged in the insulating case to be spaced apart from each other, and the ceramic coating layer may include: a first ceramic coating layer that covers an outer surface of any one of the pair of terminal plates and one surface of the insulating case; and a second ceramic coating layer that covers an outer surface of the other of the pair of terminal plates and an opposite surface of the insulating case.

The heating module may further include: an outer clip that covers the first ceramic coating layer and the second ceramic coating layer and protects the first ceramic coating layer and the second coating layer.

In accordance with another aspect of the present disclosure, there is provided a heater assembly including: a heating module that is inserted into a heat transfer pocket formed in a heater case; and a wedge that is arranged between at least one surface of the heating module and the heat transfer pocket, wherein the heating module includes: an insulating case; at least one heat emitting element that is supported by the insulating case; at least one terminal plate that is arranged in the insulating case to contact the heat emitting element; and a ceramic insulator that is arranged on an outer surface of the terminal plate.

A pair of terminal plates may be arranged in the insulating case to be spaced apart from each other, and the ceramic insulator includes: a first ceramic insulating pad that covers an outer surface of any one of the pair of terminal plates and one surface of the insulating case; and a second ceramic insulating pad that covers an outer surface of the other of the pair of terminal plates and an opposite surface of the insulating case.

The ceramic insulating pad may further include a third ceramic insulating pad that connects the first ceramic insulating pad and the second ceramic insulating pad.

The heating module may further include an outer clip that presses the first ceramic insulating pad to any one of the pair of terminal plates, and presses the second ceramic insulating pad to the other of the pair of terminal plates, and the wedge makes surface-contact with the outer clip.

The heating module may further include an outer clip, and the ceramic insulator includes a ceramic coating layer that is coated on a surface of the outer clip, which faces the terminal plate.

A pair of terminal plates may be arranged in the insulating case to be spaced apart from each other, the ceramic coating layer includes: a first ceramic coating layer that is coated on a surface of the outer clip, which faces any one of the pair of terminal plates, to cover both of an outer surface of any one of the pair of terminal plates and one surface of the insulating case; and a second ceramic coating layer that is coated on a surface of the outer clip, which faces the other of the pair of terminal plates, to cover both of an outer surface of the other of the pair of terminal plates and an opposite surface of the insulating case, and the wedge makes surface-contact with the outer clip.

The ceramic insulator may include a ceramic coating layer that is coated on the outer surface of the terminal plate and the outer surface of the insulating case.

A pair of terminal plates may be arranged in the insulating case to be spaced apart from each other, and wherein the ceramic coating layer may include: a first ceramic coating layer that covers an outer surface of any one of the pair of terminal plates and one surface of the insulating case; and a second ceramic coating layer that covers an outer surface of the other of the pair of terminal plates and an opposite surface of the insulating case.

Any one of the first ceramic coating layer and the second ceramic coating layer may make surface-contact with one surface of the wedge, and the other of the first ceramic coating layer and the second ceramic coating layer makes surface-contact with the heat transfer pocket.

The heater assembly further include: an outer clip that covers the first ceramic coating layer and the second ceramic coating layer to make surface-contact with the wedge and the heat transfer pocket.

### BRIEF DESCRIPTION OF THE DRAWINGS

FIG. 1 is a view illustrating an air conditioning system of an electric vehicle in which a heater assembly is assembled according to an embodiment of the present disclosure;

FIG. 2 is a perspective view illustrating a heater assembly according to an embodiment of the present disclosure;

FIG. 3 is a plan view illustrating the interior of a heater assembly according to the embodiment of the present disclosure;

FIG. 4 is a perspective view illustrating a state in which a bus bar block of FIG. 1 is extracted to the outside;

FIG. 5 is a perspective view illustrating a state in which a heating module of FIG. 4 is extracted to the outside;

FIG. 6 is a perspective view illustrating the bus bar block, a connecting block, and a pin block together according to the embodiment of the present disclosure;

FIG. 7 is a view illustrating the bus bar of the heater assembly according to the embodiment of the present disclosure;

FIG. 8 is an exploded perspective view illustrating the heater assembly according to the embodiment of the present disclosure;

FIG. 9 is a sectional view taken along a line A-A of FIG. 2;

FIG. 10 is a sectional view taken along line B-B of FIG. 2;

FIG. 11 is an enlarged perspective view illustrating a heating module and a wedge of a heater assembly according to an embodiment of the present disclosure;

FIG. 12 is an exploded perspective view of a heating module of FIG. 11;

FIG. 13 is a sectional view taken along a line I-I of FIG. 11;

FIG. 14 is a sectional view taken along line J-J of FIG. 11;

FIG. 15 is a sectional view in a state in which the heating module of FIG. 11 is mounted in a heat transfer pocket;

FIG. 16 is an exploded perspective view illustrating a heating module of a heater assembly according to another embodiment of the present disclosure;

FIG. 17 is a longitudinal sectional view illustrating a heating block of a heater assembly according to another embodiment of the present disclosure;

FIG. 18 is a transverse sectional view illustrating a heating block of a heater assembly according to another embodiment of the present disclosure;

FIG. 19 is a sectional view in a state in which the heating module of FIGS. 16 to 18 is mounted in a heat transfer pocket;

FIG. 20 is a longitudinal sectional view illustrating a heating module of a heater assembly according to another embodiment of the present disclosure;

FIG. 21 is a transverse sectional view illustrating a heating module of a heater assembly according to another embodiment of the present disclosure;

FIG. 22 is a sectional view in a state in which the heating module of FIGS. 20 to 21 is mounted in a heat transfer pocket; and

FIG. 23 is a sectional view of a case in which a heating module of a heater assembly according to another embodiment of the present disclosure is protected by an outer clip.

### DETAILED DESCRIPTION OF THE EMBODIMENTS

Hereinafter, exemplary embodiments of the present disclosure will be described in detail with reference to the accompanying drawings.

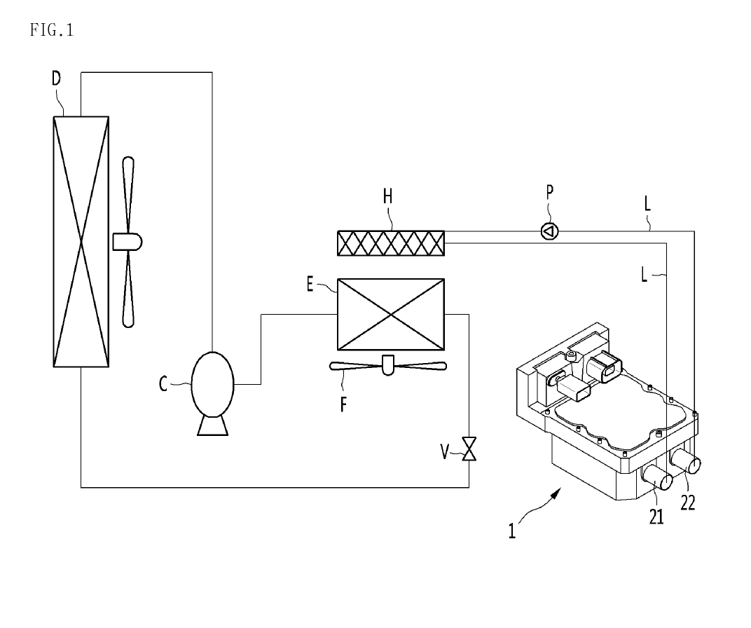

FIG. 1 is a view illustrating an air conditioning system of an electric vehicle in which a heater assembly is assembled according to an embodiment of the present disclosure.

The heater assembly 1 may be installed in an electric vehicle, and may be a heater assembly for a vehicle that heats a thermal medium, such as water, which is a hearting target (hereinafter, referred to as a thermal medium).

The heater assembly 1 may be connected to a heat exchanger H that exchanges heat with air supplied to an interior (not illustrated) of a vehicle, via a hot water line L, the thermal medium heated in the heater assembly 1 may heat the heat exchanger H while passing through the heat exchanger H, and the air supplied to the interior of the vehicle may be supplied to the interior of the vehicle after being heated by the heat exchanger H.

The hot water line L may include a water inlet line that guides the thermal medium of the heat exchanger H to the heater assembly 1, and a water outlet line that guides the thermal medium heated in the heater assembly 1 to the heat exchanger H.

A pump P that pumps the thermal medium such that the thermal medium circulates through the heat exchanger H and the heater assembly 1 may be installed in the hot water line L.

The electric vehicle may include a compressor C that compresses a refrigerant, a condenser D that condenses the refrigerant compressed by the compressor C, an expansion mechanism V that expands the refrigerant condensed by the condenser D, and an evaporator E that evaporates the refrigerant expanded by the expansion mechanism V.

The evaporator E may constitute a heating, ventilation, and air conditioning (HVAC) system of the electric vehicle together with the heat exchanger H.

The HVAC system of the electric vehicle may further include a fan that blows air towards the evaporator E and the heat exchanger H.

When the fan F is driven, the air in the interior of the vehicle or exterior air may be discharged into the interior of the vehicle after passing through the evaporator E and the heat exchanger H.

During an operation of cooling the interior of the vehicle, the compressor C and the fan F may be driven, and the air may be discharged into the interior of the vehicle after being cooled by the evaporator E.

During an operation of heating the interior of the vehicle, the heater assembly 1, the fan F, and the pump P may be driven, the thermal medium may flow to the heat exchanger H after being heated by the heater assembly 1 to heat the heat exchanger H, and the air may be discharged into the interior of the vehicle after being heated by the heat exchanger H.

Meanwhile, the heater assembly 1 may be equipped with a hot line connector to which the hot water line is connected, and a plurality of hot line connectors may be formed in the heater assembly 1.

The hot water line connector may include an inlet 21 through which the thermal medium in the water inlet line enters the interior of the heater assembly 1, and an outlet 22 through which the hot water heated in the heater assembly 1 passes to be discharged to the water outlet line.

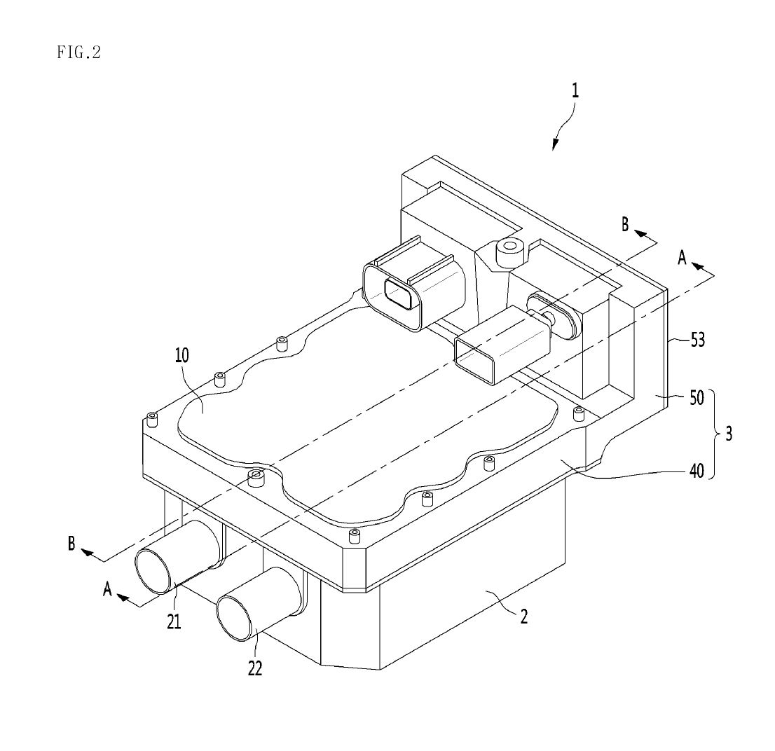

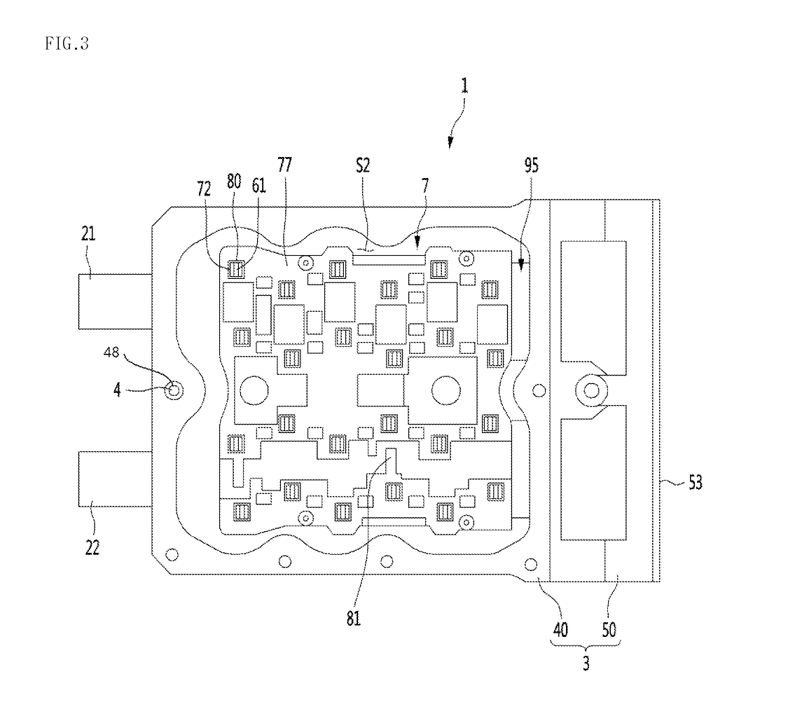

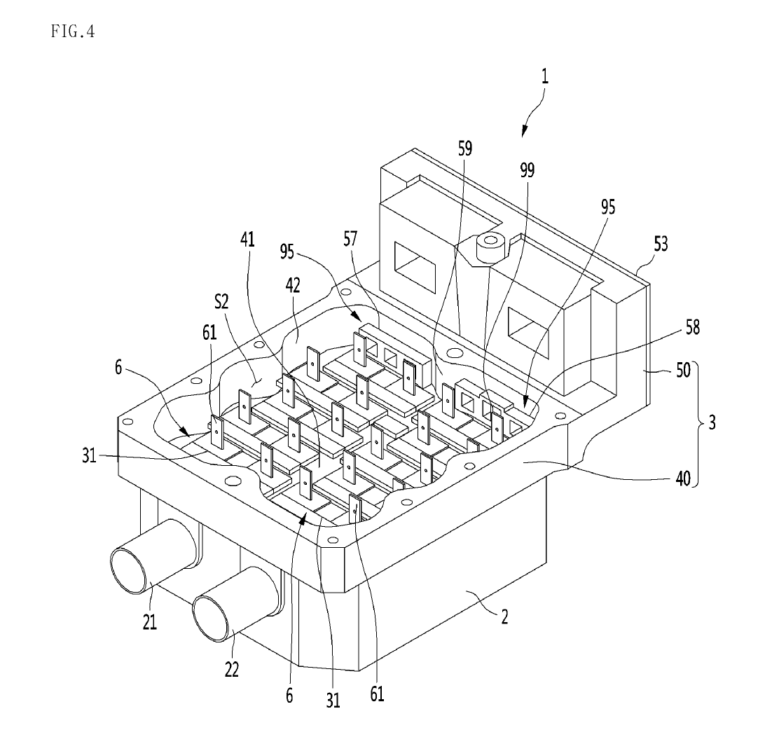

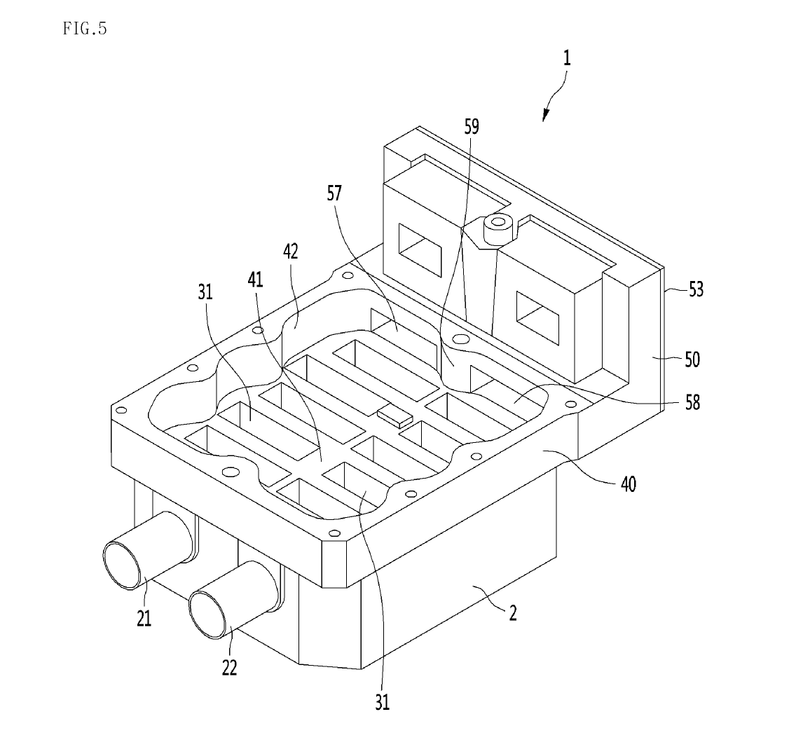

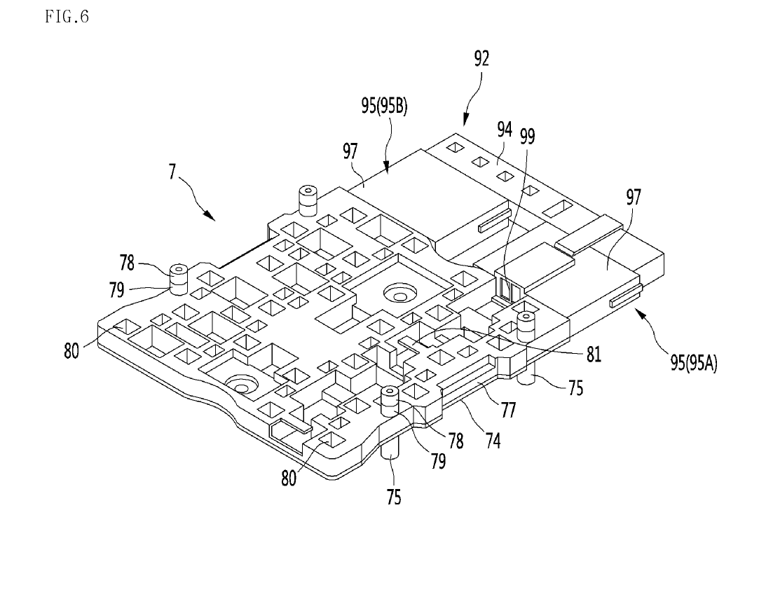

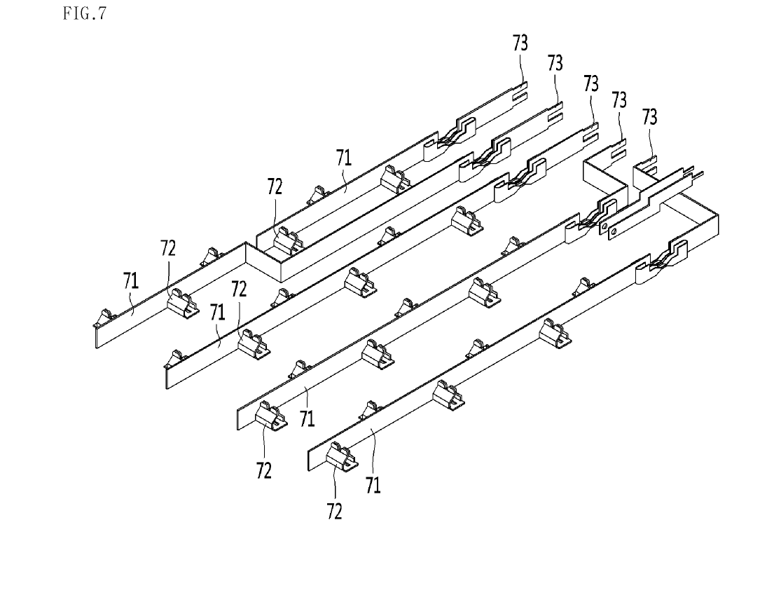

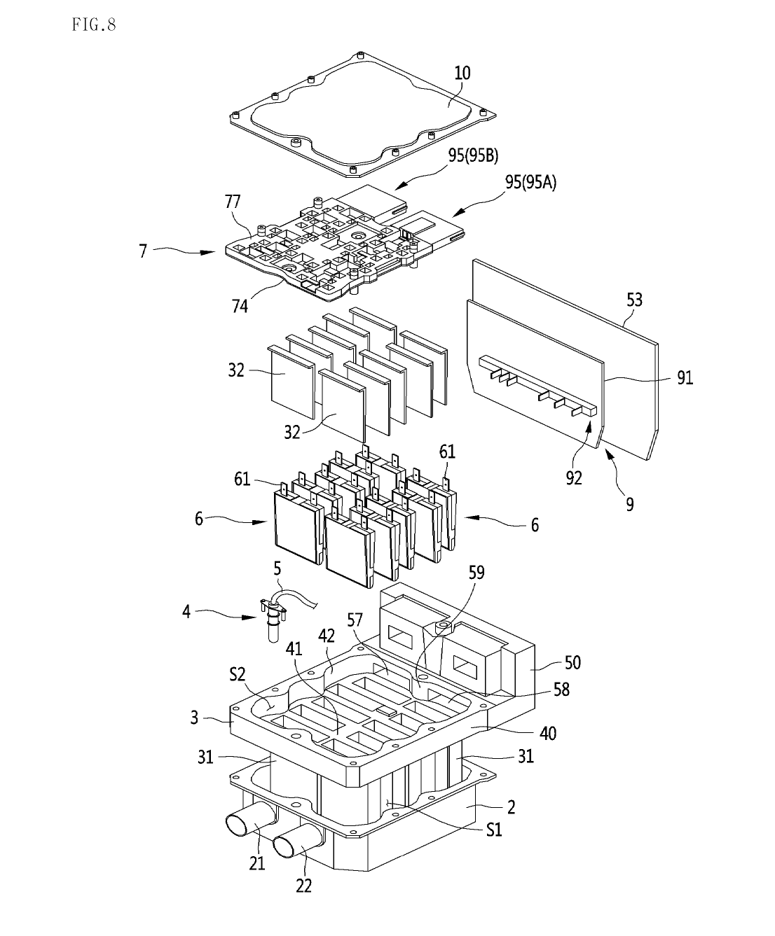

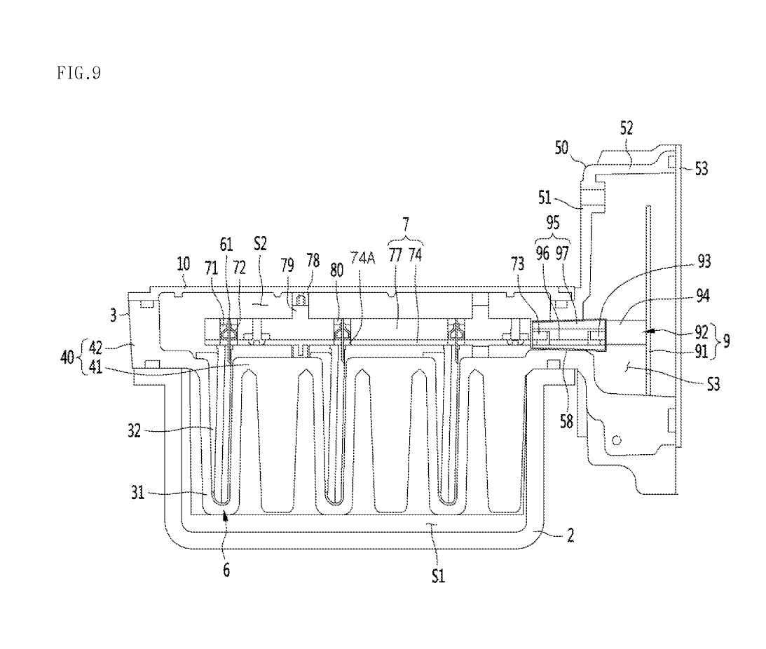

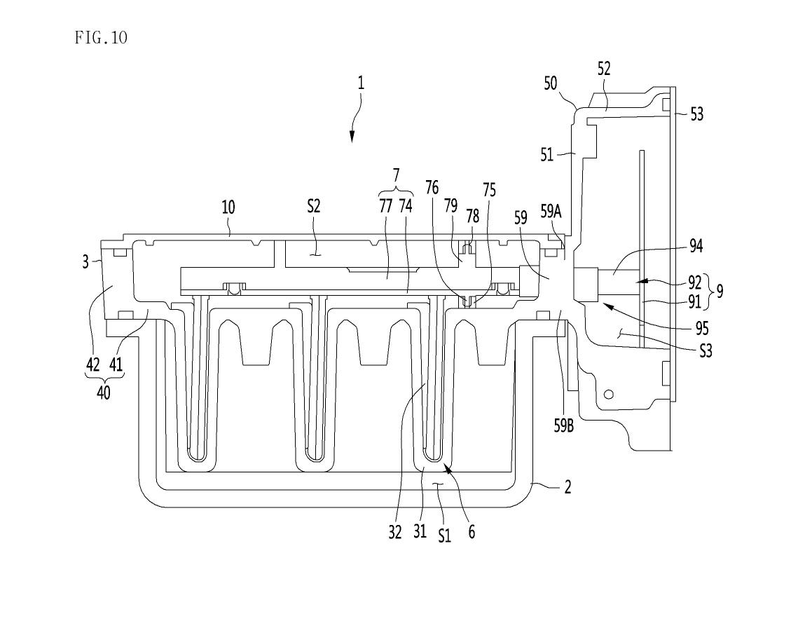

FIG. 2 is a perspective view illustrating a heater assembly according to an embodiment of the present disclosure. FIG. 3 is a plan view illustrating the interior of a heater assembly according to the embodiment of the present disclosure. FIG. 4 is a perspective view illustrating a state in which a bus bar block of FIG. 3 is extracted to the outside. FIG. 5 is a perspective view illustrating a state in which a heating module of FIG. 4 is extracted to the outside. FIG. 6 is a perspective view illustrating the bus bar block, a connecting block, and a pin block together according to the embodiment of the present disclosure. FIG. 7 is a view illustrating the bus bar of the heater assembly according to the embodiment of the present disclosure. FIG. 8 is an exploded perspective view illustrating the heater assembly according to the embodiment of the present disclosure. FIG. 9 is a sectional view taken along a line A-A of FIG. 2. FIG. 10 is a sectional view taken along line B-B of FIG. 2.

The heater assembly 1 includes a lower tank 2, a heater case 3, a heating module 6, a bus bar block 7, and a Printed Circuit Board (PCB) module 9.

The lower tank 2 may be equipped with an inlet 21 and an outlet 22, and may have a first space S1. One of an upper surface, a front surface, a rear surface, a left surface, and a right surface of the lower tank 2 may be opened, and a first space S1 may be formed in the interior of the lower tank 2.

The inlet 21 and the outlet 22 may be formed on a circumferential wall of the lower tank 2.

The inlet 21 may be an opening through which the thermal medium that is a heating target of the heater assembly 1 passes to be introduced into the first space S1.

The outlet 22 may be an opening through which the thermal medium heated in the first space S1 passes to be discharged.

At least one of the inlet 21 and the outlet 22 may be an opening that is formed on one side wall of the lower tank 2 such that the thermal medium passes therethrough.

At least one of the inlet 21 and the outlet 22 may be a hollow cylinder that protrudes from one side surface of the lower tank 2 in any one of an outward direction and an inward direction and has a passage, through which the thermal medium passes, therein.

The heater case 3 may be arranged to cover the first space S1, and may be coupled to the lower tank 2 to prevent the thermal medium in the first space S1 from being discharged through the opened surface of the lower tank 2. The heater case 3 may be larger than the lower tank 2. The heater case 3 may be a lower tank cover.

When the upper surface of the lower tank 2 is opened, the heater case 3 may contact an upper end of the lower cover 2 to cover the opened upper surface of the lower tank 2. As another example, when one of the front surface, the rear surface, the left surface, and the right surface of the lower tank 2 is opened, the heater case 3 may contact a circumferential wall of the lower cover 2 to cover the opened surface of the lower tank 2.

A second space S2 that is partitioned from the first space S1 may be formed in the heater case 3. The second space S2 may be a space in which terminals 61 of heating modules 6 and a bus bar block 7 are accommodated.

The heater case 3 may include a heat transfer pocket 31 situated in the first space S1, and the heat of the heating modules 6 may be transferred to the first space S1 through the heat transfer pocket 31. The heat transfer pocket 31 may be formed in the heater case 3 to protrude into the first space S1.

The heat transfer pocket 31 may be a heating module accommodating part in which the heating modules 6 are inserted and accommodated, and may be a heat transfer part that receives the heat of the heating modules 6 and transfers the heat to the first space S1.

The heat transfer pocket 31 may have a 3D shape, one surface of which is opened, and the heating modules 6 may be inserted into the heat transfer pocket 31 through the opened surface of the heat transfer pocket 31. The heat transfer pocket may have a shape, the surfaces of which, except for the opening surface, are blocked for insertion of the heating modules 6.

An upper surface of the heat transfer pocket 31 may be opened, and the heating modules 6 may be inserted into the heat transfer pocket 31 through the opened upper surface of the heat transfer pocket 31 at an upper location of the heat transfer pocket 31.

An opened surface of the heat transfer pocket 31 may be opened, and a lower surface and a circumferential surface of the heat transfer pocket 31 may be blocked. The circumferential surface of the heat transfer pocket 31 may include a front surface, a rear surface, a left surface, and a right surface thereof, and in this case, all the lower surface, the front surface, the rear surface, the left surface, and the right surface of the heat transfer pocket 31 may be blocked.

The heat transfer pocket 31 may protrude from the heat case 3 to a lower side. A lower end of the heat transfer pocket 31 may contact an inner bottom surface of the lower tank 2 or may be spaced apart from the inner bottom surface of the lower tank 2.

The heat transfer pocket 31 may vertically extend in the first space S1. The thermal medium in the first space S1 may contact an outer surface of the heat transfer pocket 31, and the heat transfer pocket 31 may be a heat transfer part that transfers the heat of the heating modules 6 to the thermal medium in the first space S1.

A plurality of heat transfer pockets 31 may be formed in the heater case 3. The plurality of heat transfer pockets 31 may be spaced apart from the heater case 3. The plurality of heat transfer pockets 31 may be arranged in parallel to each other in the first space S1.

Apertures, through which the thermal medium may pass, may be formed between the plurality of heat transfer pockets 31. The thermal medium introduced into the first space S1 may flow while passing through the apertures between the plurality of heat transfer pockets 31.

The plurality of heat transfer pockets 31 may be arranged in zigzags in the first space S1. The thermal medium may be primarily heated by any one of the plurality of heat transfer pockets 31, and may be secondarily heated by another one of the plurality of heat transfer pockets 31. The thermal medium may be heated in multi-stages by at least two heat transfer pockets 31.

The heater case 3 may include a heating body 40 in which the heat transfer pockets 31 and the second space S2 are formed.

Further, the heater case 3 may include a PCB body 50 in which a third space S3, in which a PCB module 9 is accommodated, is formed. The PCB body 50 may be formed integrally with the heating body 40.

The heater case 3 may include a base 41, and a circumferential wall 42 that protrudes from the base 41 and has the second space S2 therein.

The heat transfer pockets 31 may protrude from the base 41 to a lower side. The heat transfer pockets 31 may protrude from the base 41 towards the first space S1.

The second space S2 may be defined by the base 41 and the circumferential wall 42. The base 41 may define the bottom surface of the second space S2, and the circumferential wall 42 may define a circumferential surface of the second space S2.

The heating body 40 may include all of the heat transfer pockets 31, the base 41, and the circumferential wall 42. The heat transfer pockets 31 and the circumferential wall 42 may protrude from the base 41 in opposite directions. The heat transfer pockets 31 may protrude from the base 41 to the lower side, and the circumferential wall 42 may protrude from the base 41 to the upper side.

The heater assembly 1 may further include a temperature sensor 4 that detects a temperature of the first space S1.

The temperature sensor 4 is mounted in a sensor mounting hole 48 formed in the heater case 3, and one end of the temperature sensor 4 may be situated in the first space S1. A portion of the temperature sensor 4 may be inserted into and mounted in the sensor mounting hole 48 such that a lower end of the temperature sensor 4 is situated in the first space S1.

The sensor mounting hole 48 may be formed in the heating body 40. The sensor mounting hole 48 may be formed in the base 41 of the heating body 40. The sensor mounting hole 48 may be formed in a portion of the base 41 except the heat transfer pockets 31.

An electric wire 5 may be connected to the temperature sensor 4, and the electric wire 5 may be connected to a sensor connector 99 installed in the connecting block 95 or the PCB module 9, which will be described below.

The electric wire 5 and the sensor connector 99 may be connected to each other or spaced from each other by a male/female connector structure. A female connector may be provided in any one of the electric wire 5 and the sensor connector 99, and a male connector, at least a portion of which is inserted into and connected to the female connector, may be provided in the other of the electric wire 5 and the sensor connector 99.

The temperature sensor 4 may transmit a signal based on a measurement result to the PCB module 9 through the electric wire 5 and the sensor connector 99, and the PCB module 9 may detect a current temperature of the heater assembly 1 according to the signal transmitted by the temperature sensor 4.

The sensor mounting hole 48 may be formed on a side that is opposite to the PCB body 50, and the electric wire 5 may be connected to the sensor connector 99 while at least a portion of the electric wire 5 is situated in the second space S2. The structure that supports the electric wire 5 will be described below.

The PCB body 50 may have a shape, one surface of which is opened. The PCB body 50 may include a vertical plate 51 that is perpendicular to the base 41.

The PCB body 50 may further include a circumferential wall 52 that protrudes from the vertical plate 51 and has a third space S3 therein.

The circumferential wall 52 may include an upper plate and a lower plate that are vertically spaced apart from each other. The circumferential wall 52 may further include a second vertical plate that connects one side of the upper plate and one side of the lower plate and extends vertically, and a third vertical plate that connects an opposite side of the upper plate and an opposite side of the lower plate and extends vertically.

The third space S3 may be defined by the vertical plate 51, an upper plate, a second vertical plate, a lower plate, and a third vertical plate of the PCB body 50.

The heater assembly 1 may further include a PCB cover that covers the third space S3. The PCB module 9 may be situated between the PCB body 50 and the PCB cover 53. The PCB module 9 may be fixed to at least one of the PCB body 50 and the PCB cover 53. The PCB module 9 may vertically extend in the third space S3.

The heater case 3 may be formed such that the second space S2 and the third space S3 are not interrupted from each other but communicated with each other.

The heater case 3 may have at least one through hole 57 and 58 that communicates the second space S2 and the third space S3. The at least one through hole 57 and 58 may be formed for electrical connector of the heating module 6 and the PCB module 9.

The at least one through hole 57 and 58 may be formed to be horizontally opened, and the second space S2 in which the bus bar block 7 is accommodated and the third space S3 in which the PCB module 9 is accommodated may be communicated with each other by the at least one through hole 57 and 58.

One of the circumferential walls 42 of the heating body 40 may be situated between the second space S2 and the third space S3 of the heater case 3. The at least one through hole 57 and 58 may be formed at a portion of the circumferential wall 42, which is situated between the second space S2 and the third space S3, to be opened horizontally.

The heater assembly 1 may further include a heater cover 10 that covers the second space S2. The heater cover 10 may hide the bus bar block 7, and may block the second space S2 and the bus bar block 7 such that the second space S2 and the bus bar block 7 are not visible from the outside.

The heating body 40 may have a shape, an upper surface of which is opened, and in this case, the heater cover 10 may be arranged on an upper side of the heating body 40 to cover the second space S2 situated below the heater cover 10. The heater cover 10 may be a top cover of the heater assembly 1.

When the heater assembly 1 is serviced, the heater cover 10 may be separated from the heater case 3, and the, the second space S2 and the bus bar block 7 may be viewed through the opened upper surface of the heater case 3.

At least one heating module 6 may be arranged in the heater case 3. A plurality of heating modules 6 may be mounted on the heater case 3, and the plurality of heating modules 6 may heat the heater case 3 together.

The heating modules 6, except for the upper surfaces thereof, may be surrounded by the heat transfer pockets 31 when being inserted into the heat transfer pockets 31, and portions of the heating modules 6, which are inserted into the heat transfer pockets 31, may directly contact the heat transfer pockets 31 or may contact wedges 32 in contact with the heat transfer pockets 31.

The heating modules 6 may be inserted into the heat transfer pockets 31, the wedges 32 may be inserted into the apertures between the heating modules 6 and the heat transfer pockets 31, and the wedges 32 may fix the heating modules 6 in the interiors of the heat transfer pockets 31.

The wedges 32 may be arranged between the heating modules 6 and the heat transfer pockets 31 to function as press members that adheres the heating modules 6 to the heat transfer pockets 31.

Further, the wedges 32 may function as heat transfer members that transfer the heat of the heating modules 6 to the heat transfer pockets 31. It is preferable that the wedges 32 be formed of a material having a high heat transfer performance.

The heating modules 6 may be electrically connected to the PCB module 9 through the bus bar block 7, and may be electric heating modules that are heated if an electric voltage is applied thereto. Each of the heating modules 6 may include a heating element that is heated if a current flows therethrough. The heating elements of the heating modules 6 may be PTC elements.

Each of the heating modules 6 may include a pair of terminal plates, which the corresponding heating element contact, and the heating element may be arranged between the pair of terminal plates to contact the pair of terminal plates. A terminal 61 that is electrically connected to the bus bar 71 may be formed in each of the pair of terminal plates.

Each of the heating modules 6 may include two protruding terminals. Any one of the two terminals may be connected to a positive electrode bus bar of the bus bar block 7 to contact the positive electrode bus bar, and the other of the two terminals may be connected to a negative electrode bus bar of the bus bar block 7 to contact the negative electrode bus bar.

The heating modules 6 may be inserted into and mounted on the heat transfer pockets 31. When the heating modules 6 is inserted into and mounted on the heat transfer pockets 31, the terminals 61 may be situated in the second space S2 and the portions of the heating modules 6, except for the terminals 61, may be situated in the interiors of the heat transfer pockets 31.

When the plurality of heating modules 6 are mounted on the heater case 3, the plurality of terminals 61 may be situated in the second space S2, and the bus bar block 7 may be accommodated in the second space S2 to be connected to the plurality of terminals 61 situated in the second space S2.

When the top cover 10 does not cover the second space S2, the bus bar block 7 may be inserted into the second space S2, and may be connected to the terminals 61 of the heating modules 6 in the second space S2.

The plurality of heating modules 6 connected to the bus bar block 7 may be connected to each other through the bus bar block 7. The plurality of heating modules 6 may extend vertically, the bus bar block 7 may be arranged in the second space S2 to extend horizontally, and the plurality of heating modules 6 and the bus bar block 7 may be supported by each other. The bus bar block 7 may be firmly supported on the plurality of heating modules 6 mounted on the heater case 3.

The bus bar block 7 may be accommodated in the second space S2, and may be connected to the terminals 61 of the heating modules 6.

The bus bar block 7 may include bus bars 71, and at least one bus bar plate 74 and 77 in which the bus bars 71 are arranged.

The bus bars 71 may contact the terminals 61, and may be electrically connected to the heating modules 6 through the terminals 61.

A terminal contact part 72, which the corresponding terminal 61 contacts, may be formed in each of the bus bars 71.

A plurality of bus bars 71 may be provided in the bus bar block 7, and in this case, the plurality of bus bars 71 may contact the terminals 61 of the plurality of heating modules 6. For example, the terminals of two to ten heating modules 6 may contact one bus bar 71.

The plurality of bus bars 71 may be spaced apart from each other. The plurality of bus bars 71 may be horizontally spaced apart from each other. The plurality of bus bars 71 may extend horizontally, and may be spaced apart from each other in a direction that is perpendicular to the lengthwise directions thereof.

Some of the plurality of bus bars 71 may be positive electrode bus bars, and the remaining ones of the plurality of bus bars 71 may be negative electrode bus bars.

The bus bar plate 74 and 77 may include a first bus bar plate 74 in which the corresponding bus bar 71 is arranged. A terminal through-hole 75, through which the corresponding terminal 61 passes, may be formed in the first bus bar plate 74.

The bus bar plate 74 and 77 may further include a second bus bar plate 77 that is coupled to the first bus bar plate 74. The second bus bar plate 77 may constitute the bus bar block 7 together with the first bus bar plate 74 and the plurality of bus bars 71.

The bus bar 71 may be fixed to at least one of the first bus bar plate 74 and the second bus bar plate 77. A bus bar fixing part that fixes the bus bars may be formed in at least one of the first bus bar plate 74 and the second bus bar plate 77. The bus bar fixing part may include a pair of insertion ribs or insertion recesses that are formed in at least one of the first bus bar plate 74 and the second bus bar plate 77 such that the first bus bar 71 is fixedly fitted therewith.

The bus bars 71 may arranged on an upper surface of the first bus bar plate 74.

The bus bars 71 may extend in a direction that is parallel to a direction in which the plurality of heating modules 6 is spaced apart from each other. Each of the bus bars 71 may have a bar shape, and a plurality of terminals 61 may contact the bus bars 71. That is, the plurality of heating modules 6 may be connected to the bus bars 71 to be connected to each other.

A bus bar fixing part by which the bus bars 71 are supported upright may be formed in the first bus bar plate 74. Lower ends of the bus bars 71 may be inserted into the bus bar fixing part of the first bus bar plate 74.

The bus bar fixing part formed in the first bus bar plate 74 may correspond to bus bar insertion recesses that are formed on an upper surface of the first bus bar plate 74, and in this case, lower ends of the bus bars 71 may be inserted into the bus bar insertion recesses and the bus bars 71 may be fixed to the first bar plate 74.

The bus bar fixing part formed in the first bus bar plate 74 may correspond to a pair of insertion ribs that protrude upwards from an upper surface of the first bus bar plate 74, and in this case, lower ends of the bus bars 71 may be inserted between the pair of insertion ribs and the bus bars 71 may be fixed to the first bar plate 74.

The first bus bar plate 74 may protect the bus bars 71 between the base 41 of the heater case 3 and the bus bars 71. A bottom surface of the first bus bar plate 74 may face an upper surface of the base 41 of the heater case 3.

The first bus bar plate 74 may vertically face the base 41 of the heater case 3, and may prevent heat of the lower side of the first bar plate 74 from being rapidly transferred to the upper side of the first bus bar plate 74. That is, a temperature of the lower side of the first bus bar plate 74 may be maintained to be maximally high by the first bus bar plate 74.

The first bus bar plate 74 may prevent heat of the first bus bar plate 74 from being rapidly transferred from the lower side of the bus bars 71 to the upper side of the bus bars 71, and may reduce rising of the temperatures of the bus bars 71.

Terminal through-holes 77, through which the terminals 61 pass, may be formed in the first bus bar plate 74, and the terminals 61 may pass through the terminal through-holes 77 from the heating modules 6 situated below the first bus bar plate 74 to contact the bus bars 71.

The first bus bar plate 74 may be spaced apart from the heater case 3. The first bus bar plate 74 may be arranged between the heater case 3 and the heater cover 10 to be spaced apart from the heater case 3 and the heater cover 10.

First impact absorbing members 75 that contact the heater case 3 may be coupled to the first bus bar plate 74.

The first impact absorbing members 75 may be coupled to the first bus bar plate 74 to contact the base 41 of the heater case 3. First impact absorbing member mounting parts 76, on which the first impact absorbing members 75 are mounted, may be formed in the first bus bar plate 74.

The first impact absorbing members 75 may be formed of a resilient material such as rubber or silicon. When the bus bar block 7 is mounted, the first impact absorbing members 75 may be pressed between the base 41 of the heater case 3 and the first bus bar plate 74 to support the bus bar block 7 and alleviate an impact due to vibration or the like. The first impact absorbing members 75 may be bus bar block supports or spacers that support the bus bar block 7 such that the bus bar block 7 is spaced apart from the base 41 of the heater case 3.

The second bus bar plate 77 may be arranged on the first bus bar plate 74, and may cover the upper surface of the first bus bar plate 74.

A bus bar fixing part by which the bus bars 71 is supported upright may be formed in the second bus bar plate 77. Upper ends of the bus bars 71 may be inserted into the bus bar fixing part of the second bus bar plate 77.

The bus bar fixing part formed in the second bus bar plate 77 may correspond to bus bar insertion recesses that are formed on a bottom surface of an upper plate of the second bus bar plate 77, and in this case, upper ends of the bus bars 71 may be inserted into the bus bar insertion recesses and the bus bars 71 may be fixed to the second bus bar plate 77.

The bus bar fixing part formed in the second bus bar plate 77 may correspond to a pair of insertion ribs that protrude downward on a bottom surface of the second bus bar plate 77, and in this case, lower ends of the bus bars 71 may be inserted between the pair of insertion ribs and the bus bars 71 may be fixed to the first bar plate 74.

When being coupled to the first bus bar plate 74, the second bus bar plate 77 may protect the bus bars 71 from the upper side of the bus bars 71, and the bus bars 71 may be arranged between the first bus bar plate 74 and the second bus bar plate 77.

The second bus bar plate 77 may be arranged between the heater case 3 and the heater cover 10 to be spaced apart from the heater case 3 and the heater cover 10.

Second impact absorbing members 78 that contact the heater cover 10 may be coupled to the second bus bar plate 77.

Second impact absorbing member mounting parts 79, on which the second impact absorbing members 78 are mounted, may be formed in the second bus bar plate 77. The second impact absorbing members 78 may be formed of a resilient material such as rubber or silicon.

When the top cover 10 is mounted after the bus bar block 7 is mounted, the second impact absorbing members 78 may be pressed between the top cover 10 and the second bus bar plate 77 to reduce shaking of the bus bar block 7 and to alleviate an impact due to vibration or the like.

The second impact absorbing members 78 may be spacers that press the bus bar block 7 such that the bus bar block 7 is spaced apart from the top cover 10.

An opening 80, through which the terminals 61 and the terminal contact parts 72 may be identified, may be formed in the second bus bar plate 77. The opening 80 may be formed on the upper side of the terminals 61 and the terminal contact parts 72 to be opened.

When the bus bar block 7 is inserted into the second space S2, the terminals of the plurality of heating modules 6 may pass though the terminal through-holes 77 of the first bus bar plate 74.

The terminals 61 of the plurality of heating modules 6 may contact the terminal contact parts 72 of the bus bars 71, and the plurality of the heating modules 6 may be connected to the bus bars 71 through the terminals 61, respectively.

Meanwhile, an operator who assembles the heater assembly 1 may identify the contact states of the terminals 61 and the terminal contact parts 72 through the opening 80 of the second bus bar plate 77. Then, the bus bar block 7 may be reliably assembled with the plurality of heating modules 6.

An electric wire guide 81, by which an electric wire 5 connected to the temperature sensor 4 is guided, may be formed in at least one of the first bus bar plate 74 and the second bus bar plate 77. It is preferable that the electric wire guide 81 be situated in the upper one of the first bus bar plate 74 and the second bus bar plate 77, and it is preferable that the electric wire guide 81 is formed in the second bus bar plate 77.

The electric wire guide 81 may include an electric wire accommodating hole which is formed in the second bus bar plate 77 and in which a portion of the electric wire is accommodated, and a protrusion that protrudes from the second bus bar plate 77 into the electric wire accommodating hole such that the electric wire contacts the protrusion. The size of the protrusion may be smaller than the size of the electric wire accommodating hole. One end of the protrusion may protrude from the second bus bar plate 77, and an opposite end of the protrusion may be a free end. The electric wire 5 may be bent once such that a portion of the electric wire 5 is situated in the electric wire accommodating hole. If necessary, the electric wire 5 may have a shape that is wound on the protrusion at least once.

The temperature sensor 4 may be mounted after the bus bar block 7 is completely mounted, and the electric wire 5 connected to the temperature sensor 4 may be wired to the electric wire guide 81 of the bus bar block 7 accommodated in the second space S2 such that the electric wire 5 is fixed to the electric wire guide 81 to contact the electric wire guide 81.

The PCB module 9 may control the heating modules 6. The PCB module 9 may be electrically connected to the heating modules 6 through the bus bar block 7, and may apply an electric voltage to the heating modules 6 through the bus bar block 7.

The PCB module 9 may include a PCB 91, and a pin block 92 that is installed on a surface of the PCB 91, which faces the bus bar block 7.

The PCB 91 may vertically extend in the third space S3.

One surface of the PCB 91 may face an inner surface of the PCB body 50 and the bus bar block 7, and an opposite surface of the PCB 91 may face the PCB cover 53.

The pin block 92 may be installed on one surface of the PCB 91 to protrude towards the bus bar block 7.

The pin block 92 may include a pin 93 that is connected to the PCB 91, and a pin receptacle 94 that surrounds the pin 93.

The pin block 92 may be coupled to the bus bar block 7 while being mounted on the PCB 91. The bus bar block 7 may be coupled to the pin block 92 to be separable from the pin block 92, and may be electrically connected to the PCB 91 through the pin block 92.

The pin block 92 may be coupled to the bus bar block 7 through the connecting block 95, and in this case, the connecting block 95 may be situated between the pin block 92 and the bus bar block 7 and may be coupled to the pin block 92 and the bus bar block 7. Further, the bus bar block 7 may be electrically connected to the PCB 91 through the connecting block 95 and the pin block 92.

A portion 73 of the bus bar 71 may protrude into the connecting block 95 to be inserted into the connecting block 95.

A portion of the pin 93 may protrude into the connecting block 95 to be inserted into the connecting block 95.

The connecting block 95 may include a connector 96 that is connected to the pin 93 and the bus bar 71, and a connector receptacle 97 that surrounds the connector 96.

The connector 96 may be fitted with a portion 73 of the bus bar 71 and a portion of the pin 93 through a male/female coupling structure.

A pair of bus bar insertion parts, between which a portion of the bus bar 71 is inserted, may be formed on one side of the connector 96, which faces the second space S2. The pair of bus bar insertion parts may be face each other in a direction that is perpendicular to a direction in which a portion 73 of the bus bar 71 is inserted. The pair of bus bar insertion parts may be resiliently deformed in opposite directions if a portion 73 of the bus bar 71 is inserted between the pair of bus bar insertion parts, and may remain in contact with the portion 73 of the bus bar 71.

A pair of pin insertion parts, between which a portion of the pin 93 is inserted, may be formed on an opposite side of the connector 96, which faces the third space S3. The pair of pin insertion parts may be face each other in a direction that is perpendicular to a direction in which a portion of the pin 93 is inserted. The pair of pin insertion parts may be resiliently deformed in opposite directions if a portion of the pin 93 is inserted between the pair of pin insertion parts, and may maintain in contact with the pin 93.

In the connector 96, the pair of bus bar insertion parts and the pair of pin insertion parts may be spaced apart from each other in a lengthwise direction thereof, and the pair of bus bar insertion parts and the pair of pin insertion parts may be connected to each other by a connecting part.

The connector receptacle 97 may be a connector housing in which the connector 96 is accommodated. A horizontally opened through hole may be formed in the connector receptacle 97, and a portion 73 of the bus bar 71 and a portion of the pin 93 may be inserted through the through hole of the connector receptacle 97 to contact the connector 96.

A portion 73 of the bus bar 71 and a portion of the pin 93 may be inserted into the connector receptacle 97 from opposite sides of the connector receptacle 97.

The connecting block 95 may pass through through holes 57 and 58 between the second space S2 and the third space S3.

Meanwhile, one or a plurality of through holes may be formed in the heater case 3, but it is preferable that a plurality of through holes 57 and 58 be provided in the heater case 3.

When a plurality of through holes 57 and 58 are not formed in the heater case 3 but one horizontally extending through hole is formed in the heater case 3, a portion of the heater case 3, which is situated above the one through hole, may be bent or deformed downwards.

The heater case 3 may have partition wall 59 that is situated between the plurality of through holes 57 and 58 to partition the plurality of through holes 57 and 58.

The plurality of through holes 57 and 58 may be formed in the heater case 3 to be spaced apart from each other while the partition wall 59 is interposed therebetween. Here, the partition wall 59 is a part that connect a portion 59A situated on the upper side thereof and a portion 59B situated on the lower side thereof, and the portion 59A situated on the upper side of the partition wall 59 may be supported by the partition wall 59 and is neither bent nor deformed to the lower side.

A plurality of connecting blocks 95 may be connected to the pin block 92 and the bus bar block 7 to be spaced apart from each other. Any one 95A of the plurality of connecting blocks 95 and another one 95B of the plurality of connecting blocks 95 may be spaced apart from each other while a partition wall 59 is interposed therebetween.

The connecting block 95 may be inserted through the through holes 57 and 58 in the third space S3, and may be slid to be connected to the bus bar block 7 accommodated in the second space S2.

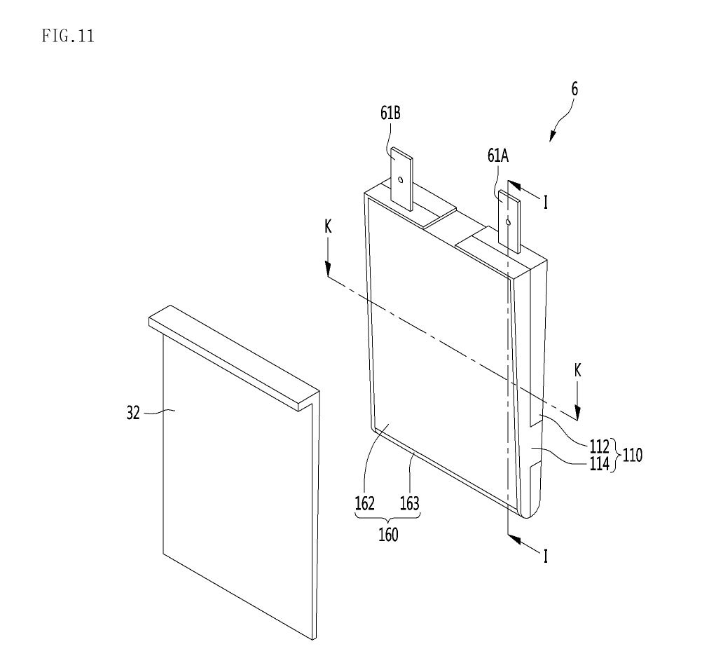

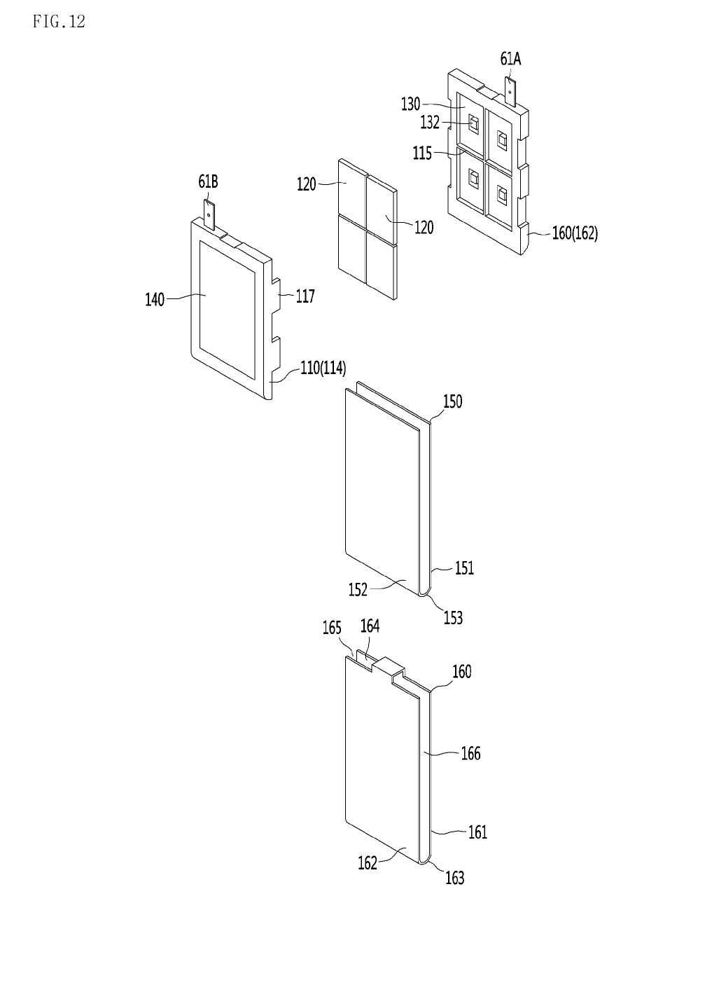

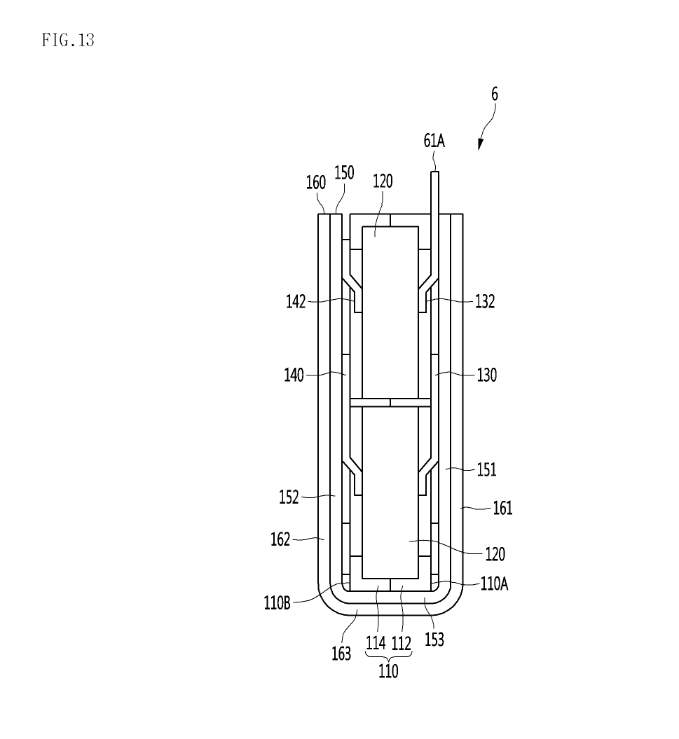

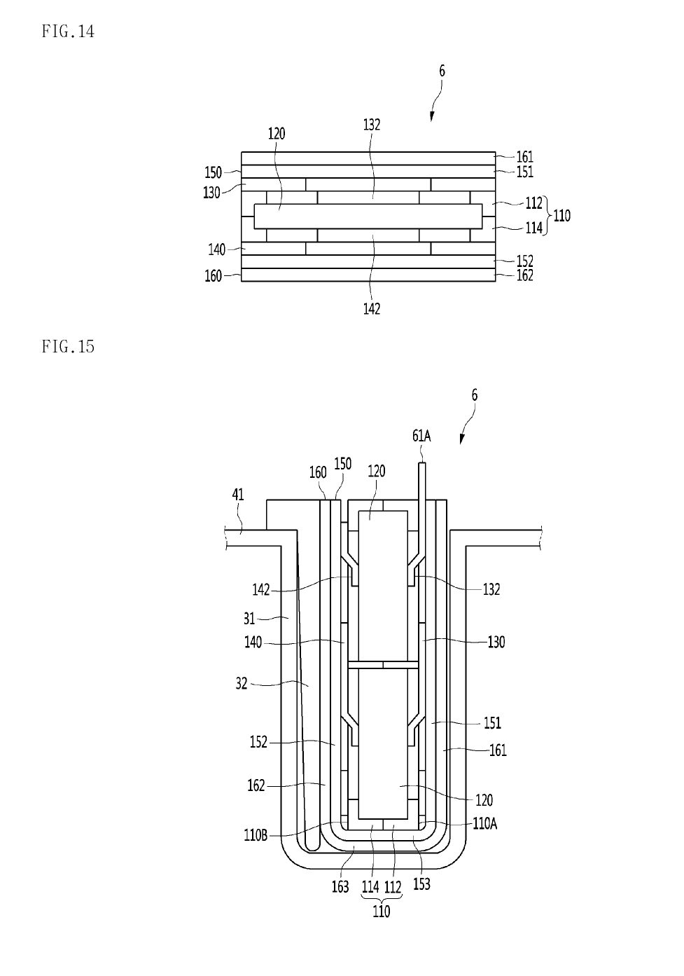

FIG. 11 is an enlarged perspective view illustrating a heating module and a wedge of a heater assembly according to an embodiment of the present disclosure. FIG. 12 is an exploded perspective view of a heating module of FIG. 11. FIG. 13 is a sectional view taken along a line I-I of FIG. 11. FIG. 14 is a sectional view taken along line K-K of FIG. 11. FIG. 15 is a sectional view in a state in which the heating module of FIG. 11 is mounted in a heat transfer pocket.

The heating module of the present embodiment may include an insulating case 110, at least one heat emitting element 120 that is supported by the insulating case 110, at least one terminal plate that is arranged in the insulating case 110 to contact the heat emitting element 120, and a ceramic insulator 150 that is arranged on an outer surface of the terminal plate.

The insulating case 110 may be an insulating housing in which the heat emitting element 120 is accommodated.

The insulating case 110 may be formed of a material that is electrically insulating and thermally conductive, and may be formed of an insulating material such as silicon or ceramic.

The insulating case 110 may have an interior space that accommodates the heat emitting element 120. A plurality of terminal plates 130 and 140 may be arranged in the insulating case 110.

The insulating case 110 may be a combination of a plurality of members. The insulating case 110 may include a first insulating case 112 to which any one of the plurality of terminal plates 130 and 140 is adhered, and a second insulating case 114 to which the other of the plurality of terminal plates 130 and 140 is adhered. The terminal plate adhered to the first insulating case 112 may be the first terminal plate 130 and the terminal plate adhered to the second insulating case 114 may be the second terminal plate 140.

An interior space, in which the heat emitting element 120 is accommodated, may be formed between the first insulating case 112 and the second insulating case 114.

A support part 115 that supports at least one heat emitting element 120 may be formed in the insulating case 110. The support part 115 may support the plurality of heat emitting elements 120 such that the plurality of heat emitting elements 130 is spaced apart from each other. The support part 115 may include a vertical support that extends longitudinally and supports the plurality of heat emitting elements 120 such that the plurality of heat emitting elements 120 are divided horizontally, and a horizontal support that extends transversely and supports the plurality of heat emitting elements 120 such that the plurality of heat emitting elements 120 are divided vertically.

The first insulating case 112 may be coupled to the second insulating case 114 by an insulating case coupling part 117 such as a hook.

The heat emitting element 120 may be a PTC element that emits heated by using a current flowing through the terminal plate. The heat emitting element 120 may be protected by the first terminal plate 130 and the second terminal plate 140 between the first terminal plate 130 and the second terminal plate 140. The heat generated by the heat emitting element 120 may be transferred to the periphery thereof. The heat generated by the heat emitting element 120 may be transferred to the first terminal plate 130, the second terminal plate 140, and the insulating guide 110, and may be transferred to the wedge 32 through the ceramic insulator 150 and the outer clip 160.

A pair of terminal plates 130 and 140 may be arranged in the insulating case 160 to be spaced apart from each other. The heating module 6 may include a pair of terminal plates 130 and 140 that are arranged in the insulating case 160 to be spaced apart from each other. The pair of terminal plates 130 and 140 may include a first terminal plate 130 that is attached to the first insulating case 112, and a second terminal plate 140 that is attached to the second insulating case 114.

A first terminal 61A may protrude from the first terminal plate 130. A second terminal 61B may protrude from the second terminal plate 140. The first terminal plate 130 and the second terminal plate 140 may be spaced apart from each other while the heat emitting element 120 is interposed therebetween.

Any one of the first terminal plate 130 and the second terminal plate 140 may be a positive electrode plate that contacts a positive electrode bus bar of the bus bar block 7 of FIGS. 9 and 10, and the other of the first terminal plate 130 and the second terminal plate 140 may be a negative electrode plate that contacts a negative electrode bus bar of the bus bar block 7 of FIGS. 9 and 10.

The terminal of any one of the first terminal plate 130 and the second terminal plate 140 may be a positive electrode terminal that contacts the positive electrode bus bar, and the terminal of the other of the first terminal plate 130 and the second terminal plate 140 may be a positive electrode terminal that contacts the negative electrode bus bar.

Hereinafter, although it will be described that the first terminal 61A of the first terminal plate 130 is a positive electrode terminal and the second terminal 61B of the second terminal plate 140 is a negative electrode terminal for convenience' sake, an opposite case may be possible.

The first terminal 61A may protrude from an upper end or a side end of the first terminal plate 130.

The second terminal 61B may protrude from an upper end or a side end of the second terminal plate 140. The second terminal 61B may protrude from the second terminal plate 140 to be spaced apart from the first terminal 61A. The second terminal 61B may be formed in parallel to the first terminal 61A.

A protrusion that protrudes towards the heat emitting element 120 to contact the heat emitting element 120 may be formed in at least one of the first terminal plate 130 and the second terminal plate 140.

When the protrusion is formed in the first terminal plate 130, it may protrude from the first terminal plate 130 towards one surface of the heat emitting element 120. The protrusion 132 of the first terminal plate 130 may be formed in an area of the first terminal plate 130, which faces the heat emitting element 120. When contacting the heat emitting element 120, the protrusion 132 of the first terminal plate 130 may be resiliently deformed. One end of the protrusion 132 of the first terminal plate 130 may be connected to the first terminal plate 130, and may be formed in the first terminal plate 130 in a bent shape. The protrusion 132 of the first terminal plate 130 may be resiliently deformed in a direction that is opposite to the heat emitting element 120 when contacting the heat emitting element 120, and a contact state of the protrusion 132 of the first terminal plate 130 and the heat emitting element 120 may be maintained.

When the protrusion is formed in the second terminal plate 140, a configuration of the protrusion may be the same as that of the protrusion formed in the first terminal plate 130 and only the locations thereof may be different. One end of the protrusion 142 of the second terminal plate 140 may be connected to the second terminal plate 140, and may be formed in the second terminal plate 140 in a bent shape. The protrusion 142 of the second terminal plate 140 may be resiliently deformed in a direction that is opposite to the heat emitting element 120 when contacting the heat emitting element 120, and a contact state of the protrusion 142 of the second terminal plate 140 and the heat emitting element 120 may be maintained.

The ceramic insulator 150 may cover both of the outer surface of the terminal plate 130 and 140 and the outer surface of the insulating case 110.

The terminal plate 130 and 140 may have an inner surface that faces the interior of the insulating case 110, and an outer surface that is covered by the ceramic insulator 150.

The ceramic insulator 150 may be larger than the terminal plate 130 and 140 and may cover the outer surface of the insulating case 110 as well as the terminal plate 130 and 140. In this case, a periphery of the terminal plate 130 and 140 and the outer surface of the insulating case 110 may be covered by the ceramic insulator 150, and an insulation performance of the ceramic insulator 150 may be higher than in the case in which the ceramic insulator 150 covers the terminal plates 130 and 140.

The thermal conductivity of the ceramic insulator 150 may be higher than that of the silicon insulator and the thermal resistance of the ceramic insulator 150 may be lower than that of the silicon insulator. The thermal conductivity of the silicon insulator is 3 W/k to 4 W/k whereas the thermal conductivity of the ceramic insulator 150 is about 16 W/k, and when the ceramic insulator 150 is provided instead of the silicon insulator, heat transfer rate may be increased while the insulation performances of the terminal plates 130 and 140 are maintained.

The ceramic insulator 150 may be configured such that any one of the two separated ceramic insulating pads may cover an outer surface of the first terminal plate 110, and the other of the two separated ceramic insulating pads may cover an outer surface of the second terminal plate 120.

One ceramic insulator 150 may cover both the outer surface of the first terminal plate 110 and the outer surface of the second terminal plate 120. In this case, a portion of the ceramic insulator 150, which covers the outer surface of the first terminal plate 110 and a portion of the ceramic insulator 150, which covers the outer surface of the second terminal plate 120 may be connected to each other by a connecting part, and thus the number of components of the heating module 6 may be reduced.

The ceramic insulator 150 may include a first ceramic insulating pad 151 that covers both of an outer surface of any one of the pair of terminal plates 130 and 140 and one surface 110A of the insulating case 110, and a second ceramic insulating pad 152 that covers both of an outer surface of the other of the pair of terminal plates 130 and 140 and an opposite surface 110B of the insulating case 160.

The ceramic insulator 150 may further include a third ceramic insulating pad 153 that connects the first ceramic insulating pad 151 and the second ceramic insulating pad 152.

The first insulating pad 151 may cover both of a surface of the first insulating case 112, to which the first terminal plate 130 is adhered, and the outer surface of the first terminal plate 130.

The second insulating pad 152 may cover both of a surface of the second insulating case 114, to which the second terminal plate 140 is adhered, and the outer surface of the second terminal plate 140.

The third insulating pad 153 may surround a side of the insulating case 110, which is opposite to the first terminal 61A and the second terminal 61B.

The first terminal 61A and the second terminal 61B may protrude from the upper surface of the insulating case 110, and the third insulating pad 153 may cover both the lower surface of the first insulating case 112 and the lower surface of the second insulating case 114.

The ceramic insulator 150 may have a substantially U shape.

The heating module 6 of the present embodiment may further include an outer clip 160. The outer clip 160 may surround the outer surface of the ceramic insulator 150.

When the heating module 6 does not include the outer clip 160, the ceramic insulator 150 may constitute the whole part or a portion of an external appearance of the heating module 6. Further, the ceramic insulator 150 may contact the wedge 32 and the heat transfer pocket 31. In this case, the heat generated by the heat emitting element 120 may be transferred to the ceramic insulator 150 through the first and second terminal plates 130 and 140, and the heat of the ceramic insulator 150 may be transferred to the wedge 32 and the heat transfer pocket 31. Because the strength of the ceramic insulator 150 is higher than the strength of the silicon insulator, the ceramic insulator 150 may not be easily worn even if it contacts the wedge 32 and the heat transfer pocket 31, and the heating module 6 may be installed such that the ceramic insulator 150 does not directly contact the wedge 32 and the heat transfer pocket 31. Of course, the present disclosure is not limited to an example of including the outer clip 160.

Meanwhile, when the heating module 6 further includes an outer clip 160, the outer clip 160 may constitute the whole part or a portion of an external appearance of the heating module 6. The outer clip 160 may be covered such that the ceramic insulator 150 is not viewed from the outside. The ceramic insulator 150 may be prevented from being exposed to the outside due to the outer clip 160.

When the outer clip 160 surrounds the ceramic insulator 150, the wedge 32 may not directly contact the ceramic insulator 150 but may contact the outer clip 160 and accordingly, the damage of the ceramic insulator due to the wedge 32 may be reduced.

It is preferable that the outer clip 160 may be a metallic clip that is formed of a metal having a strength that is higher than that of silicon. It is preferable that the outer clip 160 may be a metallic clip having a high thermal conductivity, and it is more preferable that the outer clip 150 be an aluminum clip.

It is preferable that the outer clip 160 be configured such that the ceramic insulator 150 is pressed by the first terminal plate 130 and the second terminal plate 140 from the outside of the ceramic insulator 150.

The outer clip 160 may press the first ceramic insulating pad 151 with any one 130 of the pair of terminal plates, and may press the second ceramic insulating pad 152 with the other 140 of the pair of terminal plates.

It is preferable that the outer clip 160 be fixed to the first terminal plate 130, the second terminal plate 140, the ceramic insulator 150, and the insulating case 110 without using a coupling member such as a screw.

The outer clip 160 may be resiliently deformed in a shape that is widened to surround the ceramic insulator 150. If the ceramic insulator 150 is completely inserted into the outer clip 160, the outer clip 160 may contact the ceramic insulator 150 due to restoring force thereof, and the restoring force may press the ceramic insulator 150 to the first terminal plate 130 and the second terminal plate 140.

The outer clip 160 may include a pair of plates 161 and 162 that are spaced apart from each other, and an outer connecting part 163 that connects the pair of plates 161 and 162.

One surface 164 of the outer clip 160, which faces the outer connecting part 163, and opposite surfaces 165 and 166 of the outer clip 160, which are perpendicular to the one surface 164 of the outer clip 160 may be opened. The outer clip 160 may be resiliently deformed by the structure in which the three surfaces 164, 165, and 166 are opened, and may press the first terminal plate 130 and the second terminal plate 140 to the ceramic insulator 150.

The outer clip 160 may include a first plate 161 that covers the first ceramic insulating pad 151, a second plate 162 that covers the second ceramic insulating pad 152, and an outer connecting part 163 that connects the first plate 161 and the second plate 162 and surrounds the third ceramic insulating pad 153.

The outer connecting part 163 may surround the third ceramic insulating pad 153 on a side that is opposite to the first terminal 61A and the second terminal 61B.

The outer clip 160 may have a shape that is the same as or similar to that of the ceramic insulator 150. The outer clip 160 may have a substantially U shape.

The outer clip 160 may have a surface contact part that makes surface-contact with the wedge 32. The wedge 32 may make surface-contact with at least one of the pair of plates 161 and 162 on the outside of the pair of plates 161 and 162. The outer clip 160 may have a surface contact part that makes surface-contact with one surface of the wedge 32 in any one of the pair of plates 161 and 162, and heat that is transferred to the outer clip 160 after being generated by the heat emitting element 140 may be transferred to the wedge 32.

The heating module 6 may be inserted into and fixed to the heat transfer pocket 31 together with one wedge 32, and may be inserted into and fixed to the heat transfer pocket 31 together with two wedges.

When the heating module 6 is inserted into the heat transfer pocket 31 together with one wedge 32, any one of the first and second plates 161 and 162 may make surface-contact with the wedge 32 and the other of the first and second plates 161 and 162 may make surface-contact with the heat transfer pocket 31.

When the heating module 6 is inserted into the heat transfer pocket 31 together with two wedges 32, any one of the first and second plates 161 and 162 may make surface-contact with any one of the two wedges 32 and the other of the first and second plates 161 and 162 may make surface-contact with the other of the two wedges 32.

At least a portion of the outer clip 160 may be arranged between the wedge 32 and the ceramic insulator 140, and the outer clip 150 may prevent damage to the insulation pad 150 due to the wedge 32. The outer clip 160 may function as a ceramic insulator protector that protects the ceramic insulator 150.

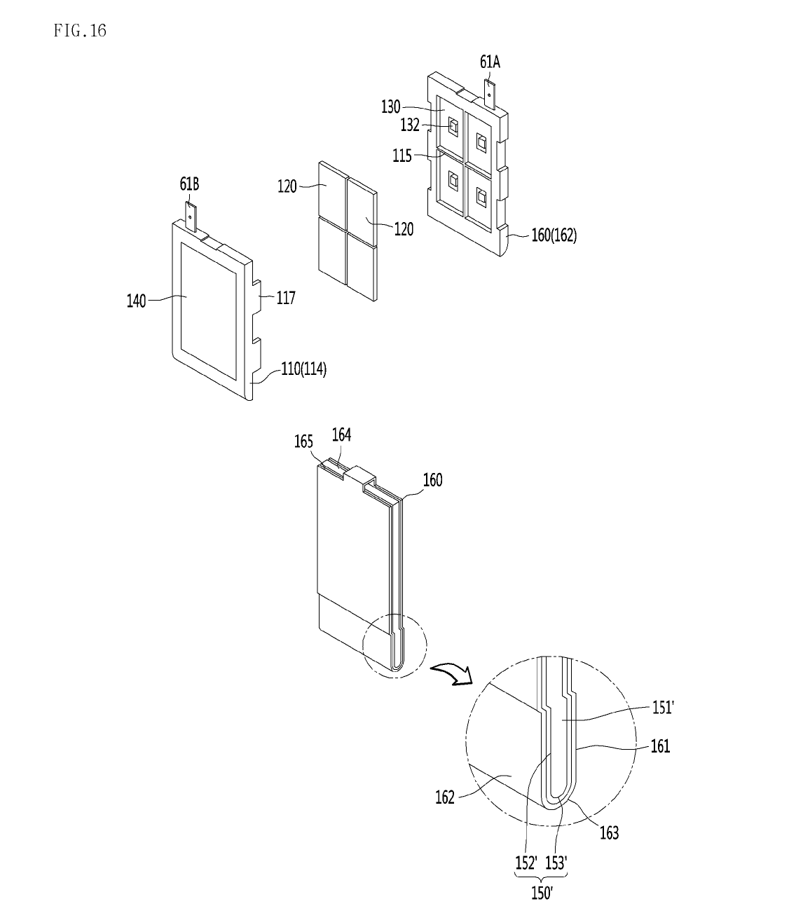

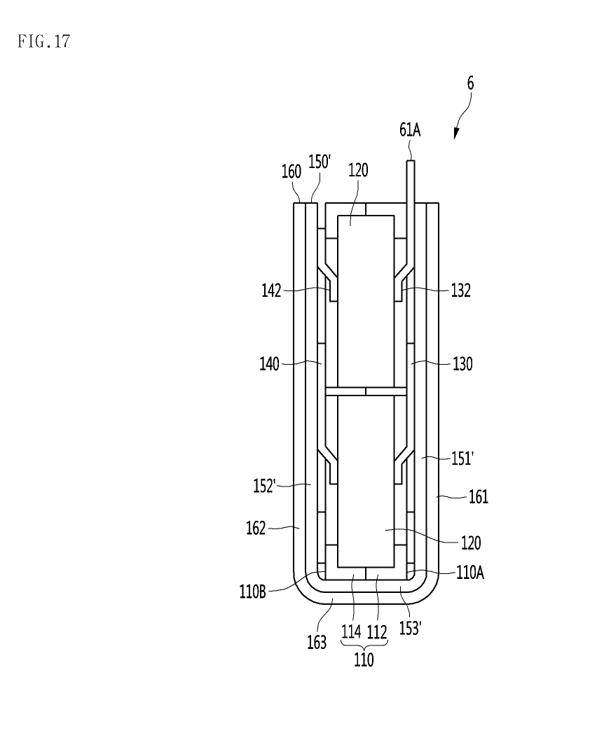

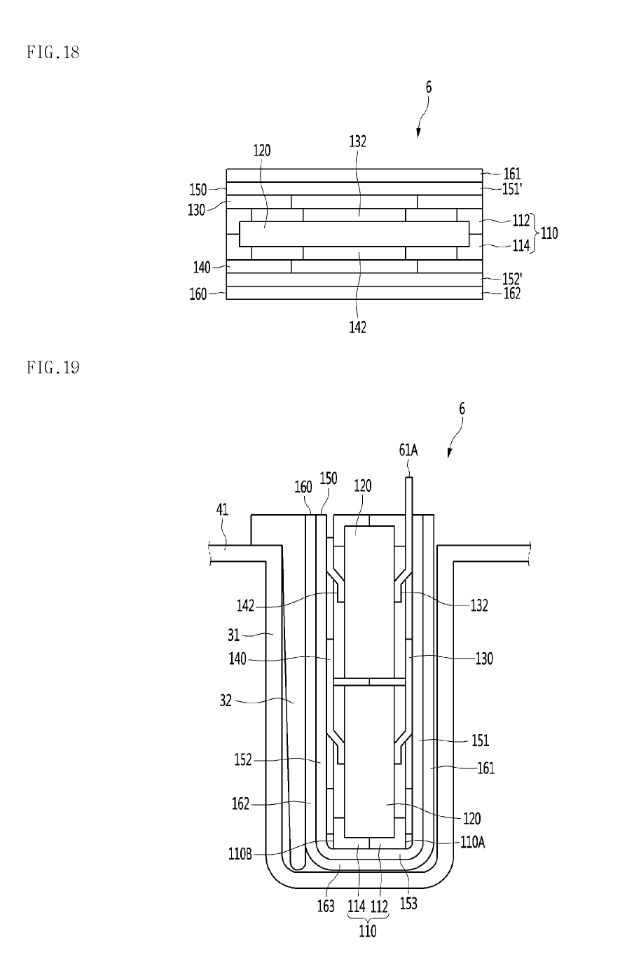

FIG. 16 is an exploded perspective view illustrating a heating module of a heater assembly according to another embodiment of the present disclosure. FIG. 17 is a longitudinal sectional view illustrating a heating module of a heater assembly according to another embodiment of the present disclosure. FIG. 18 is a transverse sectional view illustrating a heating module of a heater assembly according to another embodiment of the present disclosure. FIG. 19 is a sectional view in a state in which the heating module of FIGS. 16 to 18 is mounted in a heat transfer pocket.

The ceramic insulator of the present embodiment may include a ceramic coating layer 150′ that is coated on a surface of the outer clip 160, which faces the terminal plate 130 and 140, and the ceramic coating layer 150′ may insulate the terminal plate 130 and 140 instead of the ceramic insulating pad 151, 152, and 153 of FIGS. 11 to 15.

A pair of terminal plates 130 and 140 of the present embodiment may be arranged in the insulating case 110 to be spaced apart from each other.

As in the first embodiment, the present embodiment may include an insulating case 110, at least one heat emitting element 120, a pair of terminal plates 130 and 140, and an outer clip 160, and hereinafter, the same configurations as in the first embodiment of the present disclosure are denoted by the same reference numerals and a detailed description thereof will be omitted.

The ceramic coating layer 150′ may be a coating layer that is coated on the inner surface of the outer clip 160.

The ceramic coating layer 150 may include a first ceramic coating layer 151′ that is coated on a surface of the outer clip 160, which faces any one 130 of the pair of terminal plates 130 and 140, to cover both of an outer surface of any one of the pair of terminal plates 130 and 140 and one surface 110A of the insulating case 110, and a second ceramic coating layer 152′ that is coated on a surface of the outer clip 160, which faces the other 140 of the pair of terminal plates 130 and 140, to cover both of an outer surface of the other of the pair of terminal plates 130 and 140 and an opposite surface 110B of the insulating case 110. The ceramic coating layer 150′ may further include a third ceramic coating layer 153′ that connects the first ceramic coating layer 151′ and the second coating layer 152′.

The ceramic coating layer 150′ may heat and melt or soften a ceramic material, may convert the atomized ceramic material, and may integrally coat the ceramic material on the outer clip 160 by colliding the ceramic material with the outer clip 160 through thermal spraying

A ceramic sprayer that heated and atomized the ceramic material may inject the atomized ceramic onto an inner surface of the outer clip 160, the atomized ceramic injected onto the inner surface of the outer clip 160 may be coagulated and deposited on the inner surface of the outer clip 160, and the ceramic coating layer 150′ may be uniformly coated on the whole inner surface of the outer clip 160.

In the thermal spraying method of coating ceramic on an inner surface of the outer clip 160, a powder material that has been completely melted may be produced by introducing a ceramic material into a plasma flow that is generated from an inert gas by a non-transfer arc and instantaneously melting the ceramic material, and the powder material may be injected and adhered to the inner surface of the outer clip 160 at a high speed. A ceramic coating layer 150′ that has an excellent wear-resistant property, an excellent heat-resistant property, an excellent electrical conductivity, and an excellent electrical shield property may be formed on the inner surface of the outer clip 160.

When being integrally formed in the outer clip 160 of aluminum, the ceramic coating layer 150′ may contact the insulating case 110 and the pair of terminal plates 130 and 140.

After the insulating case 110, the at least one heat emitting element 120, and the pair of terminal plates 130 and 140 are assembled, the assembly may be inserted into the outer clip 160.

When the assembly of the insulating case 110, the at least one heat emitting element 120, and the pair of terminal plates 130 and 140 is completely inserted into the outer clip 160, it may cover the outer surfaces of the pair of terminal plates 130 and 140 and the outer surface of the insulating case 110 while the ceramic coating layer 150′ is integrally formed with the outer clip 160.

When the assembly of the at least one heat emitting element 120 and the pair of terminal plates 130 and 140 is inserted into the outer clip 160, the distance between the first plate 161 and the second plate 162 may become larger.

If the assembly is completely inserted, the first ceramic coating layer 151′ may be pressed in a direction that faces the outer surface of the first terminal plate 130 and one surface 110A of the insulating case 110, by the outer clip 160, and may be adhered to the outer surface of the first terminal plate 130.

If the assembly is completely inserted, the second ceramic coating layer 152′ may be pressed in a direction that faces the outer surface of the second terminal plate 140 and an opposite surface 110B of the insulating case 110, by the outer clip 160, and may be adhered to the outer surface of the second terminal plate 140.

In the present embodiment, the heating module 6 may be assembled while the ceramic coating layer 150′ is integrally formed on an inner surface of the outer clip 160, and may reduce the number of components when a separate ceramic pad 150 is used as in the first embodiment of the present disclosure. Further, the assembling operation may be easily performed and the reliability of the insulating performance becomes higher.

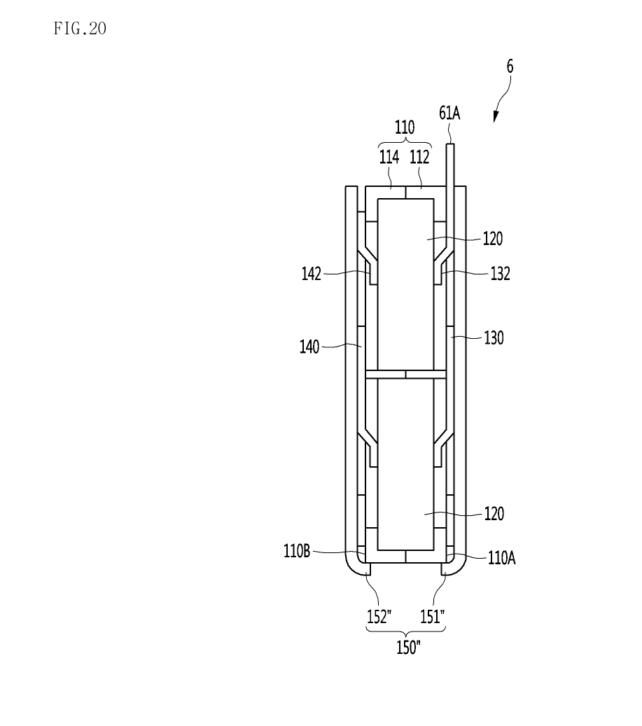

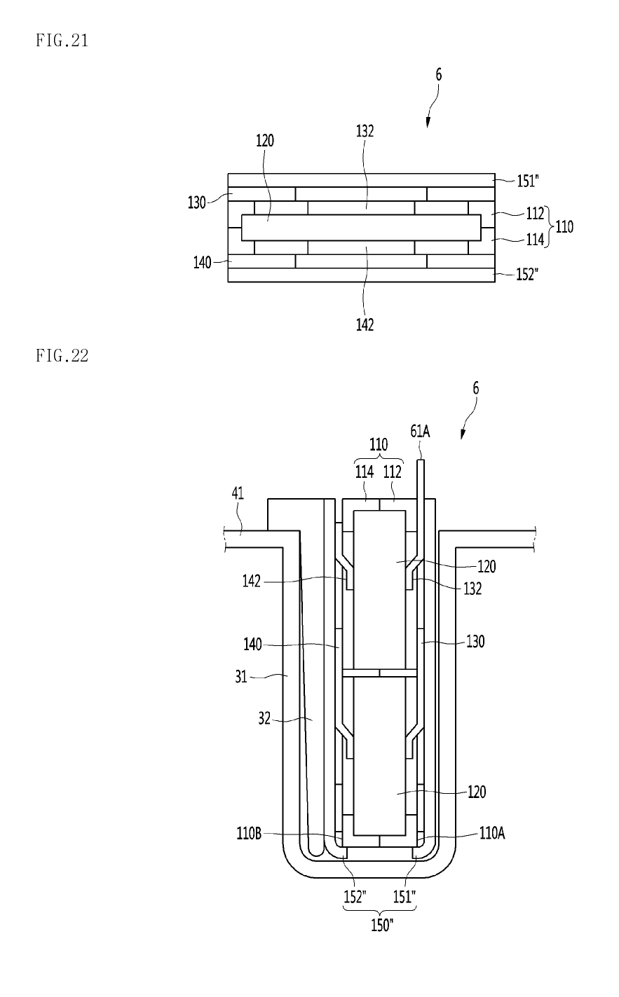

FIG. 20 is a longitudinal sectional view illustrating a heating module of a heater assembly according to another embodiment of the present disclosure. FIG. 21 is a transverse sectional view illustrating a heating module of a heater assembly according to another embodiment of the present disclosure. FIG. 22 is a sectional view in a state in which the heating module of FIGS. 20 to 21 is mounted in a heat transfer pocket.

The ceramic insulator of the present embodiment may include a ceramic coating layer 150″ that is coated on the outer surface of the terminal plate and the outer surfaces 110A and 110B of the insulating case 110, and the ceramic coating layer 150″, instead of the ceramic pad of FIGS. 11 to 15, may insulate the terminal plates 130 and 140.

A pair of terminal plates 130 and 140 of the present embodiment may be arranged in the insulating case 110 to be spaced apart from each other, as in the heater assembly of the first embodiment of the present disclosure.

As in the first embodiment, the present embodiment may include an insulating case 110, at least one heat emitting element 120, and a pair of terminal plates 130 and 140, and hereinafter, the same configurations as in the first embodiment of the present disclosure are denoted by the same reference numerals and a detailed description thereof will be omitted.

The ceramic coating layer 150″ may include a first ceramic coating layer 151″ that covers both of an outer surface of any one 130 of the pair of terminal plates 130 and 140 and one surface 110A of the insulating case 110, and a second ceramic insulating pad 152″ that covers both of an outer surface of the other 140 of the pair of terminal plates 130 and 140 and an opposite surface 110B of the insulating case 110.

In the present embodiment, the insulating case 110, the at least one heat emitting element 120, and the pair of terminal plates 130 and 140 may be assembled, and the ceramic coating layer 150″ may be coated on an outer surface of the assembly of the insulating case 110, the at least one heat emitting element 120, and the pair of terminal plates 130 and 140.

As in the other embodiments of the present disclosure, the ceramic coating layer 150″ may be coated on the outer surface of the assembly through thermal spraying.

The ceramic sprayer that heated and atomized the ceramic material may inject the atomized ceramic to one surface of the assembly to form the first ceramic coating layer 151″ that covers both of the outer surface of the first terminal plate 130 and one surface 110A of the insulating case 110.

The ceramic sprayer may inject the atomized ceramic to an opposite surface of the assembly to form the second ceramic coating layer 152″ that covers both of the outer surface of the second terminal plate 140 and an opposite surface 110B of the insulating case 110.

Because the ceramic coating layer 150′ has a strength that is higher than that of the silicon pad in the heating module 6 of the present embodiment, the heating module 6 may be inserted into and mounted on the wedge pocket 31 of FIGS. 9 and 10 without using a separate outer clip.

In the heating module 6 of the present embodiment, as illustrated in FIG. 22, any one of the first ceramic coating layer 151″ and the second ceramic coating layer 152″ may make surface-contact with one surface of the wedge 32 and the other of the first ceramic coating layer 151″ and the second ceramic coating layer 152″ may make surface-contact with the heat transfer pocket 31.

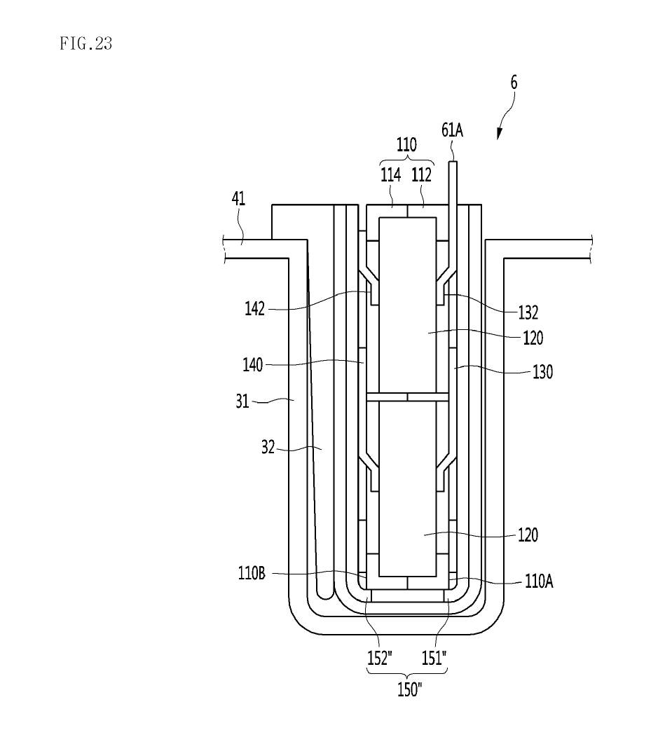

FIG. 23 is a sectional view of a case in which a heating module of a heater assembly according to another embodiment of the present disclosure is protected by an outer clip.

The present disclosure may further include an outer clip 160″ that covers the first ceramic coating layer 151″ and the second ceramic coating layer 152″ to protect the first ceramic coating layer 151″ and the second ceramic coating layer 152″.

In this case, the outer clip 160″ may surround all of the assembly of the insulating case 110, the at least one heat emitting element 120, and the pair of the terminal plates 130 and 140, the first ceramic coating layer 151″, and the second ceramic coating layer 152″, and as in the first embodiment of the present disclosure, the outer clip 160″ may make surface-contact with one surface of the wedge 32 and may make surface-contact with the heat transfer pocket 31.

According to an embodiment of the present disclosure, the ceramic insulator that has a thermal conductivity that is higher than that of the silicon pad increases heat transfer performance while insulating the electrode plate.

Further, because thermal resistance may be reduced by the ceramic insulator, the performance of the heating module can be improved.

Further, the outer clip can protect the ceramic insulator.

In addition, the size of the heating module can be compact.

The above description is a simple exemplification of the technical spirit of the present disclosure, and the present disclosure may be variously corrected and modified by those skilled in the art to which the present disclosure pertains without departing from the essential features of the present disclosure.

Therefore, the disclosed embodiments of the present disclosure do not limit the technical spirit of the present disclosure but are illustrative, and the scope of the technical spirit of the present disclosure is not limited by the embodiments of the present disclosure.

The scope of the present disclosure should be construed by the claims, and it will be understood that all the technical spirits within the equivalent range are fall within the scope of the present disclosure.

What is claimed is:

1. A heating module comprising:
an insulating case;
at least one heat emitting element supported by the insulating case;
a first terminal plate located in the insulating case to contact the heat emitting element; and
a ceramic insulator located on an outer surface of the first terminal plate.

2. The heating module of claim 1, wherein the ceramic insulator covers both of the outer surface of the first terminal plate and an outer surface of the insulating case.

3. The heating module of claim 1, further comprising a second terminal plate located in the insulating case and spaced from the first terminal plate,
wherein the ceramic insulator includes:
a first ceramic insulating pad that covers the outer surface of the first terminal plate and a first surface of the insulating case; and
a second ceramic insulating pad that covers an outer surface of the second terminal plate and a second surface of the insulating case opposite the first surface of the insulating case.

4. The heating module of claim 3, wherein the ceramic insulator includes a third ceramic insulating pad that connects the first ceramic insulating pad to the second ceramic insulating pad.

5. The heating module of claim 3, further comprising an outer clip pressing the first ceramic insulating pad to the first terminal plate and pressing the second ceramic insulating pad to the second terminal plate.

6. The heating module of claim 1, further comprising an outer clip,
wherein the ceramic insulator comprises a ceramic coating layer that is coated on a first surface of the outer clip facing the first terminal plate.

7. The heating module of claim 6, further comprising a second terminal plate located in the insulating case and spaced from the first terminal plate,
wherein the ceramic coating layer comprises:
a first ceramic coating layer that is coated on the first surface of the outer clip to cover both of the outer surface of the first terminal plate and a first surface of the insulating case; and
a second ceramic coating layer that is coated on a second surface of the outer clip facing the second terminal plate to cover both of an outer surface of the second terminal plate and a second surface of the insulating case opposite the first surface of the insulating case.

8. The heating module of claim 1, wherein the ceramic insulator comprises a ceramic coating layer that is coated on the outer surface of the first terminal plate and a first outer surface of the insulating case.

9. The heating module of claim 8, further comprising a second terminal plate located in the insulating case and spaced from the first terminal plate,
wherein the ceramic coating layer comprises:
a first ceramic coating layer that covers the first outer surface of the first terminal plate and the first outer surface of the insulating case; and
a second ceramic coating layer that covers an outer surface of the second terminal plate and a second outer surface of the insulating case opposite the first outer surface of the insulating case.

10. The heating module of claim 9, further comprising an outer clip that covers the first ceramic coating layer and the second ceramic coating layer and protects the first ceramic coating layer and the second coating layer.

11. A heater assembly comprising:
a heater case having a heat transfer pocket;
a heating module located in the heat transfer pocket in the heater case, the heating module including:
an insulating case;
at least one heat emitting element supported by the insulating case;
a first terminal plate located in the insulating case to contact the heat emitting element; and
a ceramic insulator located on an outer surface of the first terminal plate; and
a wedge located between at least one surface of the heating module and the heat transfer pocket.

12. The heater assembly of claim 11, further comprising a second terminal plate located in the insulating case and spaced from the first terminal plate,
wherein the ceramic insulator includes:
a first ceramic insulating pad that covers the outer surface of the first terminal plate and a first surface of the insulating case; and
a second ceramic insulating pad that covers an outer surface of the second terminal plate and a second surface of the insulating case opposite the first surface of the insulating case.

13. The heater assembly of claim 12, wherein the ceramic insulating pad includes a third ceramic insulating pad that connects the first ceramic insulating pad to the second ceramic insulating pad.

14. The heater assembly of claim 12, wherein the heating module further comprises an outer clip that presses the first ceramic insulating pad to the first terminal plate and presses the second ceramic insulating pad to the second terminal plate, and
wherein the wedge makes surface-contact with the outer clip.

15. The heater assembly of claim 11, wherein the heating module further comprises an outer clip, and
wherein the ceramic insulator comprises a ceramic coating layer that is coated on a first surface of the outer clip facing the first terminal plate.

16. The heater assembly of claim 15, further comprising a second terminal plate located in the insulating case and spaced from the first terminal plate,
wherein the ceramic coating layer comprises:
a first ceramic coating layer that is coated on the first surface of the outer clip to cover both of the outer surface of the first terminal plate and a first surface of the insulating case; and
a second ceramic coating layer that is coated on a second surface of the outer clip facing the second terminal plate to cover both of an outer surface of the second terminal plate and a second surface of the insulating case opposite the first surface of the insulating case, and
wherein the wedge makes surface-contact with the outer clip.

17. The heater assembly of claim 11, wherein the ceramic insulator comprises a ceramic coating layer that is coated on the outer surface of the first terminal plate and a first outer surface of the insulating case.

18. The heater assembly of claim 17, further comprising a second terminal plate located in the insulating case and spaced from the first terminal plate,
wherein the ceramic coating layer comprises:
a first ceramic coating layer that covers the outer surface of the first terminal plate and the first outer surface of the insulating case; and
a second ceramic coating layer that covers an outer surface of the second terminal plate and a second outer surface of the insulating case opposite the first outer surface of the insulating case.

19. The heater assembly of claim 18, wherein one of the first ceramic coating layer and the second ceramic coating layer makes surface-contact with one surface of the wedge, and the other of the first ceramic coating layer and the second ceramic coating layer makes surface-contact with the heat transfer pocket.

20. The heater assembly of claim 18, further comprising an outer clip that covers the first ceramic coating layer and the second ceramic coating layer to make surface-contact with the wedge and the heat transfer pocket.
